(19) United States
(12) Patent Application Publication
(10) Pub. No.: US 2009/0083137 A1
(43) Pub. Date: Mar. 26, 2009

(54) EXCHANGE MARKET PLATFORM FOR TIMESHARE PROPERTIES

(76) Inventors: Stan Tsai, Fremont, CA (US); Maria Tsai, Fremont, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/860,474

(22) Filed: Sep. 24, 2007

(51) Int. Cl. G06Q 30/00; G06F 17/10; G06F 17/30; G06F 17/40

(52) U.S. Cl. 705/14; 705/36 R; 705/37

(57) ABSTRACT

Techniques for providing exchange market platform for possessing timeshare properties are described herein. In one embodiment, a fair market price (FMP) is determined for possessing a timeshare property for a predetermined period of time in view of supply and demand of a plurality of timeshare properties having similar characteristics available for the predetermined period of time. The FMP is determined independent of buyers and sellers of the plurality of timeshare properties. In response to an offer from a buyer, a trade transaction is executed at FMP if the FMP is more than or equal to the minimum acceptance price (MAP) of a seller currently owning a right of possessing the timeshare property. Other methods and apparatuses are also described.

### COPYRIGHT NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to exchanges of real properties. More particularly, this invention relates to exchange platform for the use of timeshare real properties, commonly referred as timeshare exchange and timeshare rental.

### BACKGROUND

A timeshare is a form of vacation property ownership. With timeshares, the use and costs of running the resort are shared among the owners. While the majority of timeshares are condominiums or cooperatives at vacation destinations, developers have applied the timeshare model to houseboats, yachts, campgrounds, motor homes and cruises. Timeshare is a business model whereby a company buys/builds something and sells small time slices of it to customers. This concept is most frequently used for vacation condominiums/homes, but it has also been used for high end private jets. In general, “timeshare” refers to the former rather than the latter. Timeshares take different forms depending on the sellers. The vast majority consists of one week of deeded ownership (e.g., 1/52 year), but some developers sell point based systems that are a different form of vacation currency that also allows hotel stays, car rentals, and stays at large networks of resorts.

Timeshare owners may elect to: stay at their resort during the prescribed period; give it as a gift; exchange internally within the same resort or resort group; exchange externally into thousands of other timeshare resorts, and/or rent out their owned usage. With some point systems, owners may further elect to: assign their usage time to the point system to be exchanged for airline tickets, hotels, travel packages, cruises, amusement park tickets; instead of renting all their actual usage time, rent part of their points without actually getting any usage time and use the rest of the points; rent more points from either the internal exchange entity or another owner to get a larger unit or more vacation time or at a better location; save or move points from one year to another. While the choices are seemingly many, most of the options an owner has require long planning (e.g., 12-18 months), offer very limited flexibility and bring the owner low liquidity. The lack of an effective free market place designed for timeshare contributes to the much depressed valuation for timeshare in rental and resale.

With the boom of Internet, there are many marketplaces on the Internet. Trades are conducted between individuals through 1) bidding (e.g., eBay); 2) listing followed by bargaining/haggling between individuals (e.g., Craig's List); or 3) listing without negotiation (e.g., eBay's “Buy-it-now”). Those marketplaces are simply a virtual town center, a common place where buyers meet sellers. Trading is conducted from individual seller to individual buyer, and each item is marketed as an individual product and priced individually. The manager of the marketplace plays no role in individual trading, nor to guide and regulate the marketplace. The free market model is proved to be very successful for certain applications (e.g., selling of antiques and popular electronics at eBay).

However, customers in the vacation rental industry require more guidance from the marketplace and demand more trustworthiness. In a conventional free market model, the manager of the marketplace acts only as a listing board. An individual seller manages his/her own product marketing and provides his/her own product description. Customers assume all the risk in their purchasing. In addition, pricing of a timeshare unit is based on individual's perception of the market. Similar units can be priced drastically different from different sellers. It adds additional confusion to buyers. As a result, the free market model has limited popularity in trading of timeshare. There is thus a need for a new regulated free marketplace operating based on a different set of principles.

### SUMMARY OF THE DESCRIPTION

Techniques for providing exchange market platform for timeshare properties are described herein. In one embodiment, a fair market price (FMP) is determined for possessing a timeshare property for a predetermined period of time in view of supply and demand of a plurality of timeshare properties having similar characteristics available for the predetermined period of time. The FMP is determined independent of buyers and sellers of the timeshare properties. A seller currently owning a right of possessing the timeshare property offers the timeshare to the market with a minimum acceptance price (MAP). If the MAP is less than the FMP, the listing is valid on the market and is available to buyers to bid. A trade transaction is executed in response to an offer from a buyer to buy the timeshare at the price of FMP.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 is a block diagram illustrating a system configuration of an exchange market for timeshare properties according to one embodiment of the invention.

FIG. 2 is a block diagram illustrating an example of timeshare market exchange platform according to one embodiment.

FIG. 3 is a flow diagram illustrating a process for providing an exchange market platform for timeshare properties according to one embodiment of the invention.

FIG. 4 is a flow diagram illustrating a process of an exchange market platform for timeshare properties on behalf of a seller according to one embodiment of the invention.

FIG. 5 is a flow diagram illustrating a process of an exchange market platform for timeshare properties on behalf of a buyer according to one embodiment of the invention.

FIG. 6 is s flow diagram illustrating a process for determining an FMP of a timeshare property according to one embodiment of the invention.

FIGS. 7A-7C are diagrams illustrating an example of a trade to be executed according to certain embodiment of the invention.

FIG. 8 is a block diagram illustrating an example of configurations of certain types of express lanes according certain embodiments of the invention.

FIGS. 9A-9B are diagrams illustrating typical certain exchange models.

FIG. 9C is diagram illustrating an example of exchange model according to one embodiment of the invention.

FIGS. 10A-10F are examples of graphical user interfaces (GUIs) for an exchange market platform according to certain embodiments of the invention.

FIG. 11 is a block diagram of a data processing system which may be used with one embodiment of the invention.

### DETAILED DESCRIPTION

Techniques for providing exchange market platform for timeshare properties are described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

According to certain embodiments of the invention, a regulated free market is provided to offer services of product marketing (with common language in product description), a regulated pricing strategy for fair trade, and a mean to expedite individual selling without disruption to overall market. In addition, a pricing algorithm is utilized herein to gauge the dynamic of the market, whereas a pricing index is generated in an effort to balance the supply and demand from an overall market perspective. Further, according to one embodiment, exchange herein is conducted more effectively with a currency media, essentially in a two-step process (rent-out plus rent-in). The marketplace is a facilitator for such trading rather than an active trade partner.

Note that the exchange of timeshare real properties are commonly referred as timeshare exchange and timeshare rental. Therefore, buy and sell transactions referred herein throughout this application would be indeed rent-in and rent-out. Likewise, buyers and sellers could be indeed rentee and renter. While timeshare is the most popular format, timeshare herein mentioned covers broadly to include other format of vacation ownership including, but are not limited to, vacation club membership, cruise and golfing clubs, fractional ownership, condotel, and/or vacation home. Also note that while embodiments of the invention focus on timeshare exchange, similar principle of market exchange is applicable to trades of other redeemable assets.

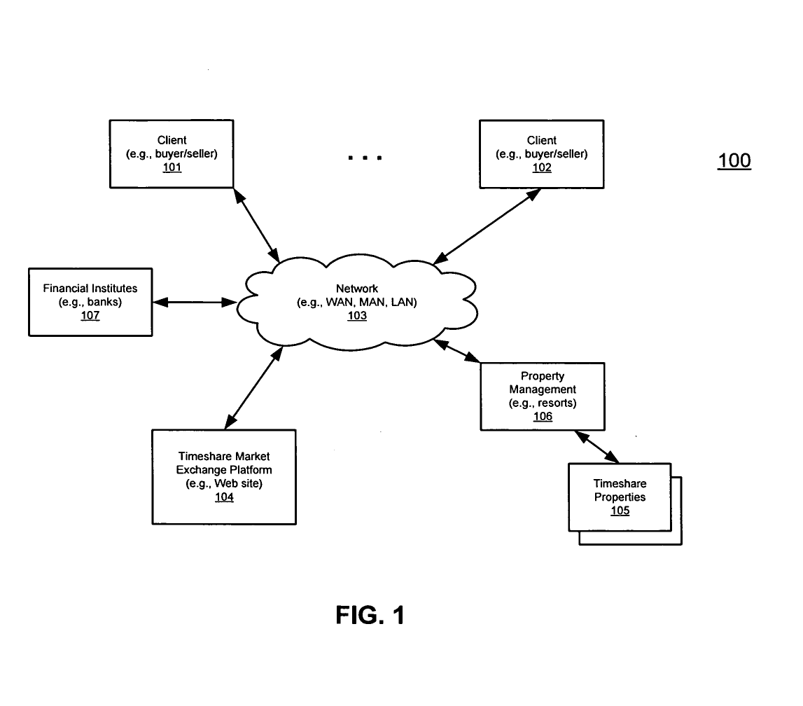

FIG. 1 is a block diagram illustrating a system configuration of an exchange market for timeshare properties according to one embodiment of the invention. Referring to FIG. 1, system 100 includes, but is not limited to, one or more clients 101-102 communicatively coupled to a timeshare market exchange platform 104 over a network 103. Network 103 may be a wide area network (WAN) such as the Internet, a local area network (LAN), a metropolitan area network (MAN), or a combination thereof. Platform 104 is used to provide an exchange market for the clients 101-102 to exchange, including buying and/or selling, the usage right of timeshare properties 105 which may be managed by a property management entity 106 (e.g., resorts).

A timeshare property may be owned by one or more owners. Note that an owner may own an entire timeshare property and alternatively, an owner may own a right to use the timeshare property for an entire year or a specific period of time of the year. Consequently, a seller may be a seller to sell the right (e.g., deeded out or rent out) to use at least a portion of time of a year of the timeshare property. Similarly, a buyer may be a buyer to buy the right (e.g., deeded in or rent in) to use at least a portion of time of a year of the timeshare property.

According to one embodiment, timeshare market exchange platform 104 is configured to provide a trading platform (e.g., a Web interface) for buyers and/or sellers to buy/rent ownership and/or right to use timeshare properties using an objectively determined fair market price (FMP) for each timeshare property on the market. The FMP is dynamically determined based on supply and demand of the market at the time independent of direct influence of the buyers and sellers. In addition, a seller may set a minimum acceptance price (MAP) for the trading. The corresponding timeshare property will be on the market as long as the MAP from the seller is below the FMP of the timeshare property. Platform 104 further provides one or more “express lanes” which can be purchased by a seller to expedite trading the corresponding timeshare property. Further, a seller can be simultaneously a buyer as well. A seller may try to sell a first timeshare property while the seller is trying to buy a second timeshare property. Platform 104 may further coordinate with certain financial institutes 107 for arrange payments for the trades.

Thus, according to certain embodiments of the invention, as the marketplace does the product marking on behalf of all sellers, a common pricing is maintained for similar products. In a traditional free market, trading price is set directly by individual traders. In a listing market, individual seller, based on his/her eagerness to sell, sets the selling price. On the other hand, in a bidding market, the trading price is set by the buyer who has the most desire to buy and offers the highest bid. Individual pricing does not take into consideration the overall supply and demand, as such it is not necessary an objective determination of the market price of a product. Different from the traditional free market, the marketplace according to one embodiment of the invention is traded based on the FMP. The products are sold only at a regulated price, the FMP. The use of common pricing facilitates exchange as it eliminates excessive pricing volatility and thus eliminates confusion to buyers. Furthermore, unlike a single-seller department store, the FMP is not a price vertically set by a single vender. The FMP is a market index, objectively determined per market dynamics according to a predetermined pricing algorithm. FMP may fluctuate up and down as the market flows to gauge and to balance supply and demand.

The marketplace provided herein is a “consignment store”. Entering such a marketplace, a seller does not open his/her own “booth” there but rather puts his/her products into existing “shelf”, alongside with similar items from other sellers. A seller retains his/her ownership until the product is sold. The seller enters contractual agreement with the marketplace that, until sold or retracted, the products will be available for sell in the marketplace under agreed upon terms. In this individual-to-individual free market, according to one embodiment, seller makes his/her offer with a minimum acceptable price (MAP). While trading is executed at FMP per overall market condition, individual seller defines the availability of his/her product on the market by MAP. A product will be automatically retracted from active listing if FMP falls below MAP. MAP is accessible to seller all the time and can be modified and/or programmed.

According to one embodiment, this marketplace does not “own” any inventory. It provides guidance how a trade will proceed but is not involved directly as a buyer or seller. Inventory in the market are commitments to sell from sellers through contractual agreement. In a traditional free market, pricing is the only knob a seller has to facilitate his/her selling. By lowering his/her price, a seller brings his/her product ahead of his/her peers and stimulates the market demand. Low pricing is an attention getter. Unfortunately, once a seller, per his/her own urgency to sell, offers his/her product for cheap-selling, the offer also undercuts other sellers on the market. It does not take consideration of overall market dynamics. “Cheap-selling” from a few individual sellers may significantly tilt the market balance and is often detrimental to a healthy and lasting marketplace. In this marketplace, however, according to one embodiment, inventory of similar products is cleared in the order of first-to-list-first-to-sell. Additionally, express lanes are created to serve the needs from some individual sellers to expedite their selling. It allows a seller to move ahead among his/her peers with no disruption to the overall pricing strategy. As the express lanes are predefined and limited, it also guarantees the right of other sellers already in the market.

In one embodiment, the system may provide user market alerts, at the request of users, for certain resorts of specific interests as the market dynamics changes. Furthermore, as part of product marketing, the marketplace may from time to time provide trade incentives, through different means but including coupons from local retailers, 2 for 1 spa from resort, etc.

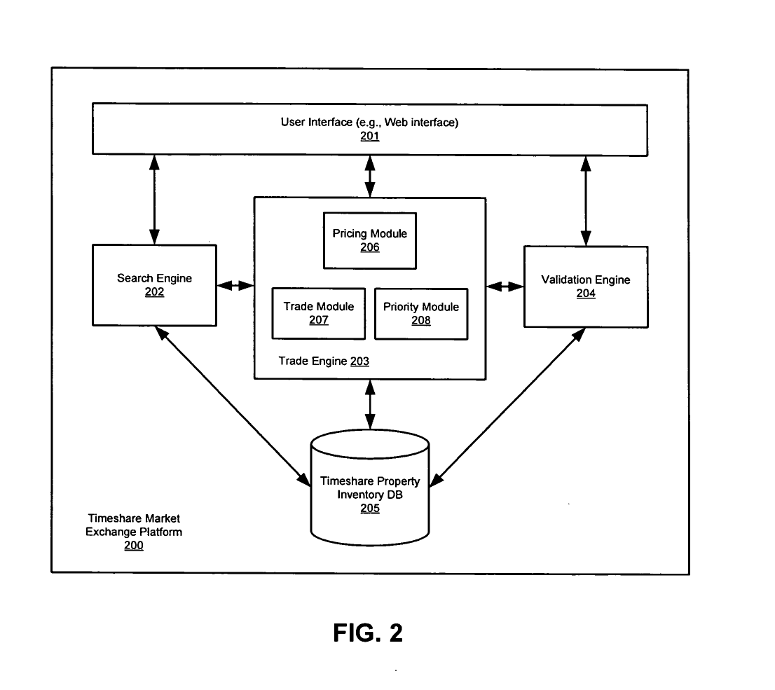

FIG. 2 is a block diagram illustrating an example of timeshare market exchange platform according to one embodiment. For example, platform 200 may be implemented as part of platform 104 of FIG. 1 which may be implemented as a Web server or a cluster of servers over a network such as the Internet. Referring to FIG. 2, according to one embodiment, timeshare market exchange platform 200 includes, but is not limited to, a user interface 201, a search engine 202, a trade engine 203, a validation engine 204, and a timeshare property inventory database 205.

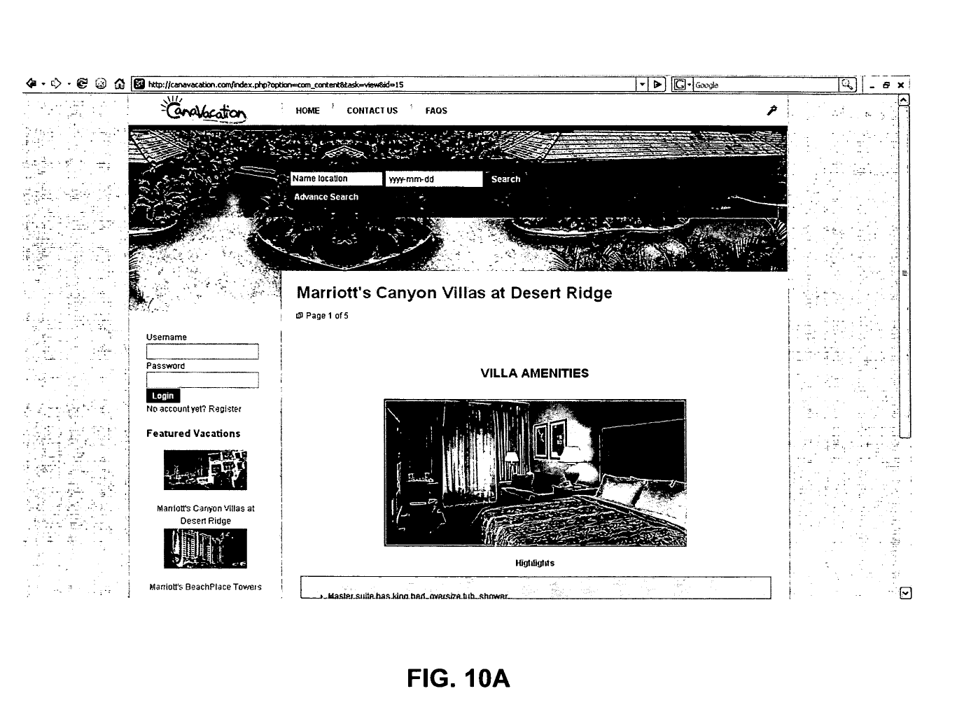

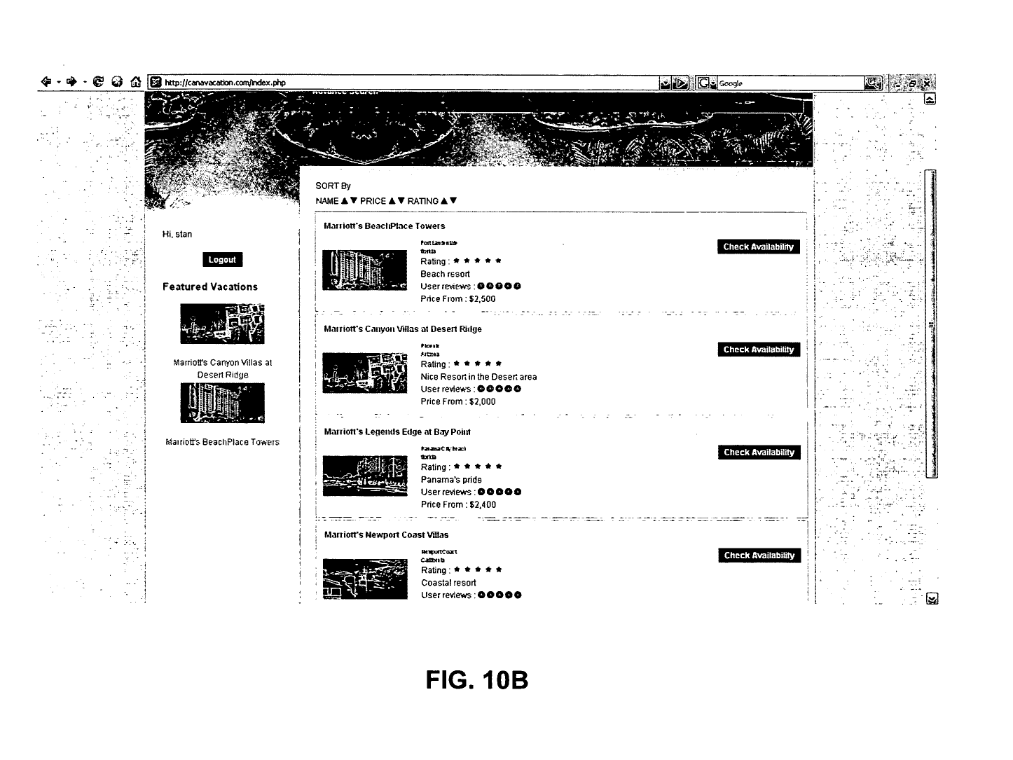

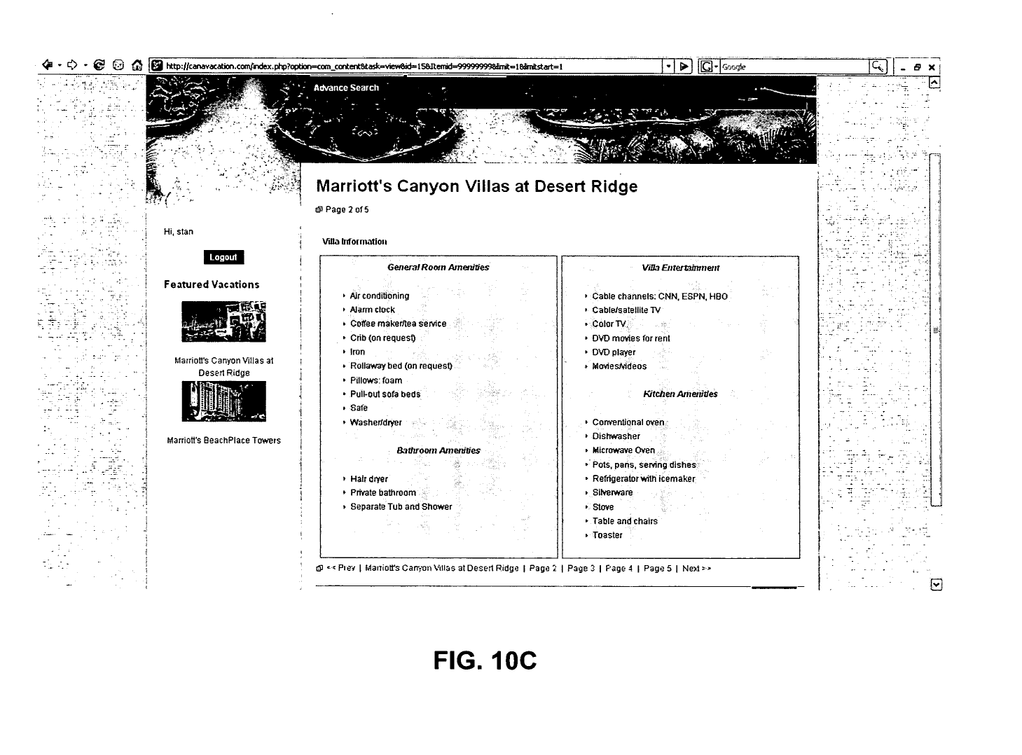

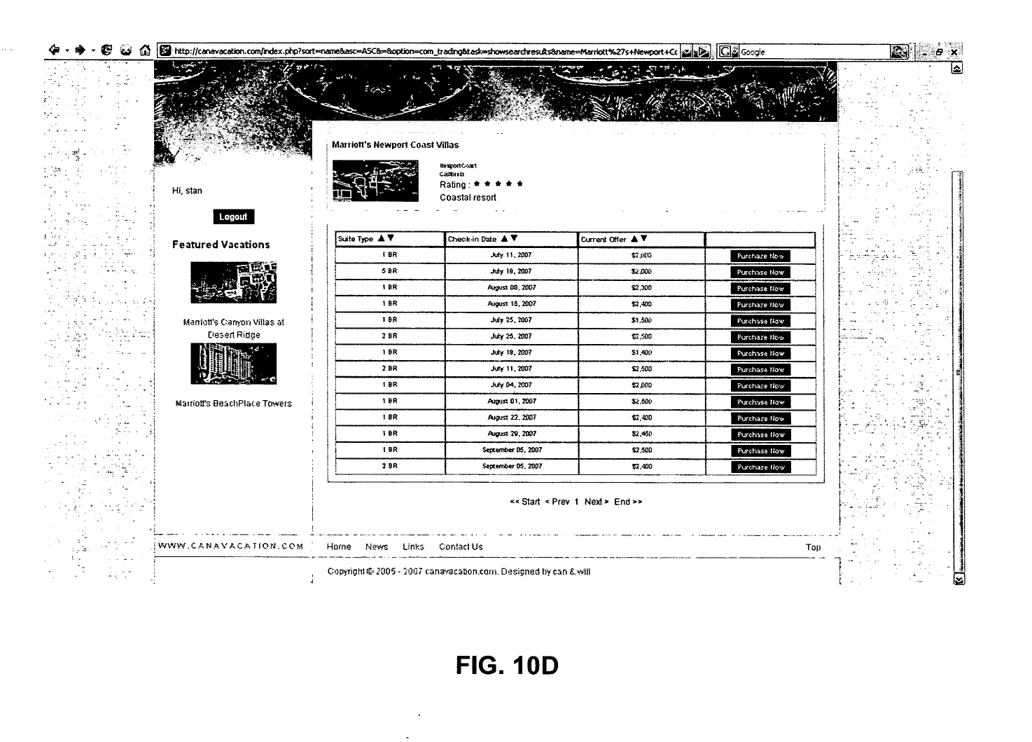

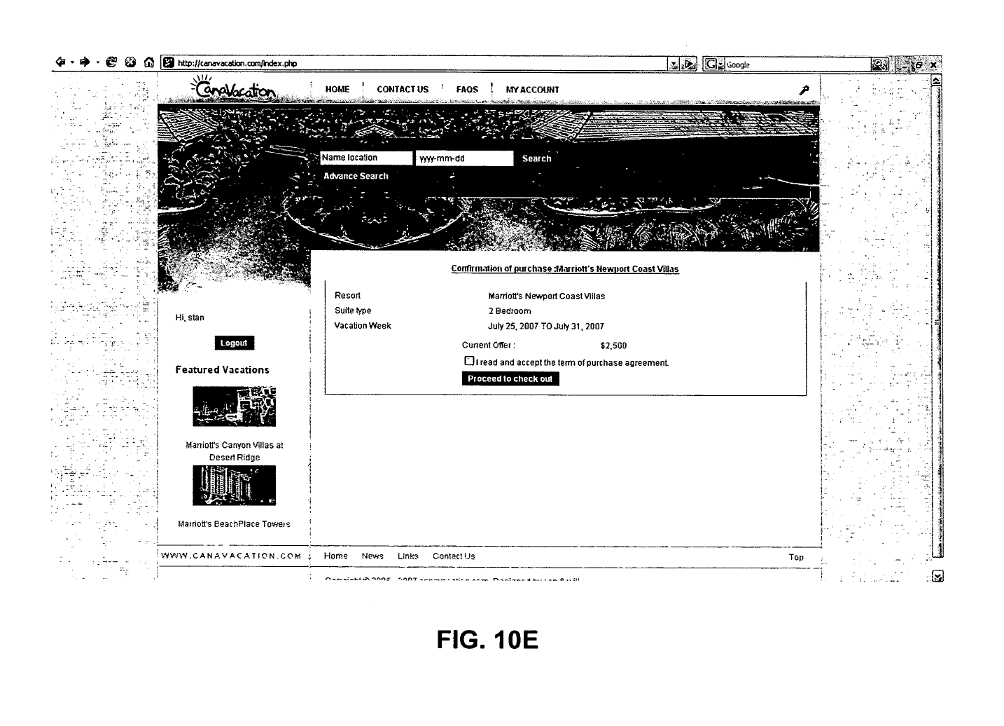

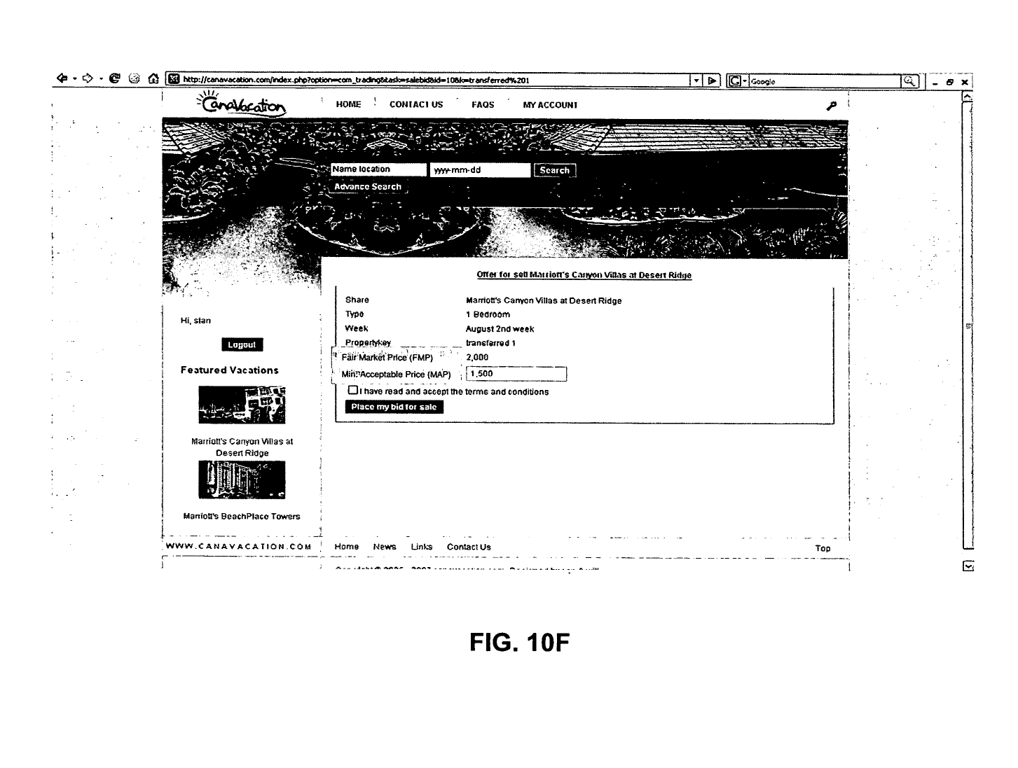

User interface (UI) 201 may be implemented as a Web interface of a Web server such as, for example, graphical user interfaces (GUIs) as shown in FIGS. 10A-10D. UI 201 is configured to provide an interface for a buyer and/or a seller to browse, configure, and/or commit a transaction of one or more timeshare properties. For example, a seller may login to its account to set a MAP for a timeshare property to be sold, as well as certain contingency conditions associated with the timeshare property. Similarly, a buyer can login to browse, bid, as well as setting other configurations or conditions associated with the buyer or a specific timeshare property. In addition, via UI 201, a seller/buyer may check any pending trade/a trade request, trading history, updates, and request an email notification, etc.

In one embodiment, search engine 202 is configured to search database 205 in response to a search request of a client (e.g., buyer/seller) via UI 201. Search engine 202 may return a resort comparison table with key features, ranking, and current market pricing, etc. According to one embodiment, for each resort (e.g., management entity 106 of FIG. 1), the search report includes a current FMP, historical trading data/chart, seasonal pricing, and/or user rating associated with the resort. In addition, the search report may includes a brief resort information (optionally with a picture or pictures), user feedbacks, certain advertisement provided by the resort, and/or a link to the resort's Web site and/or local attractions.

In one embodiment, trading engine 203 includes, but is not limited to, a pricing module 206, a trade module 207, and a priority module 208. Pricing module 206 is configured to generate an FMP for each timeshare property according to a predetermined algorithm based on supply and demand of the market. Pricing module 206 may calculate the FMP for each timeshare property listed on the market constantly or periodically (e.g., daily). Trade module 207 is configured to compare FMP vs. MAP of a particular timeshare property to decide the eligibility for each listing, constantly or periodically, and to execute a trade when certain conditions have been satisfied. Priority module 208 is configured to provide and manage certain express lanes for the expedited trades. Trade engine 203 may perform certain other operations such as sending notification emails to the clients.

In one embodiment, validation engine 204 is configured to provide an interface with member resorts to validate and hold inventories for the resorts, to confirm a trade, and/or to provide guest certificates. Validation engine 204 further provides an interface with one or more financial institutes (e.g., banks) on the payments of the trades and charges the commission therefrom. Note that some or all of the components as shown in FIG. 2 may be implemented via software, hardware, or a combination of both. Other configurations may also exist.

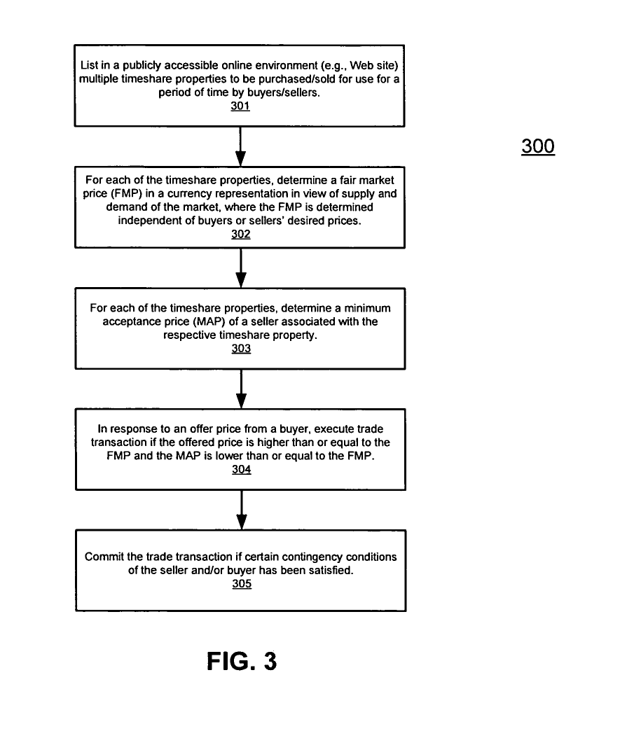

FIG. 3 is a flow diagram illustrating a process for providing an exchange market platform for timeshare properties according to one embodiment of the invention. Note that process 300 may be performed by processing logic which may include software, hardware, or a combination thereof. For example, process 300 may be performed by system 200 of FIG. 2. Referring to FIG. 3, at block 301, multiple timeshare properties are listed in a publicly accessible online ecommerce environment such as a Web site, where the timeshare properties are to be purchased and/or sold for use for a predetermined period of time by the buyers and/or sellers. At block 302, for each of the timeshare properties, processing logic determines an FMP in a currency representation in view of supply and demand of the market, where the FMP is determined independent of buyers/sellers' direct inputs. At block 303, for each of the timeshare properties, processing logic determines a MAP of a seller associated with the respective timeshare property listed. At block 304, in response to an offer from a buyer, processing logic executes the trade transaction at the price of FMP if the MAP is also lower than or equal to the FMP. At block 305, the trade transaction is committed of certain optional contingency conditions have been satisfied. Other operations may also be performed.

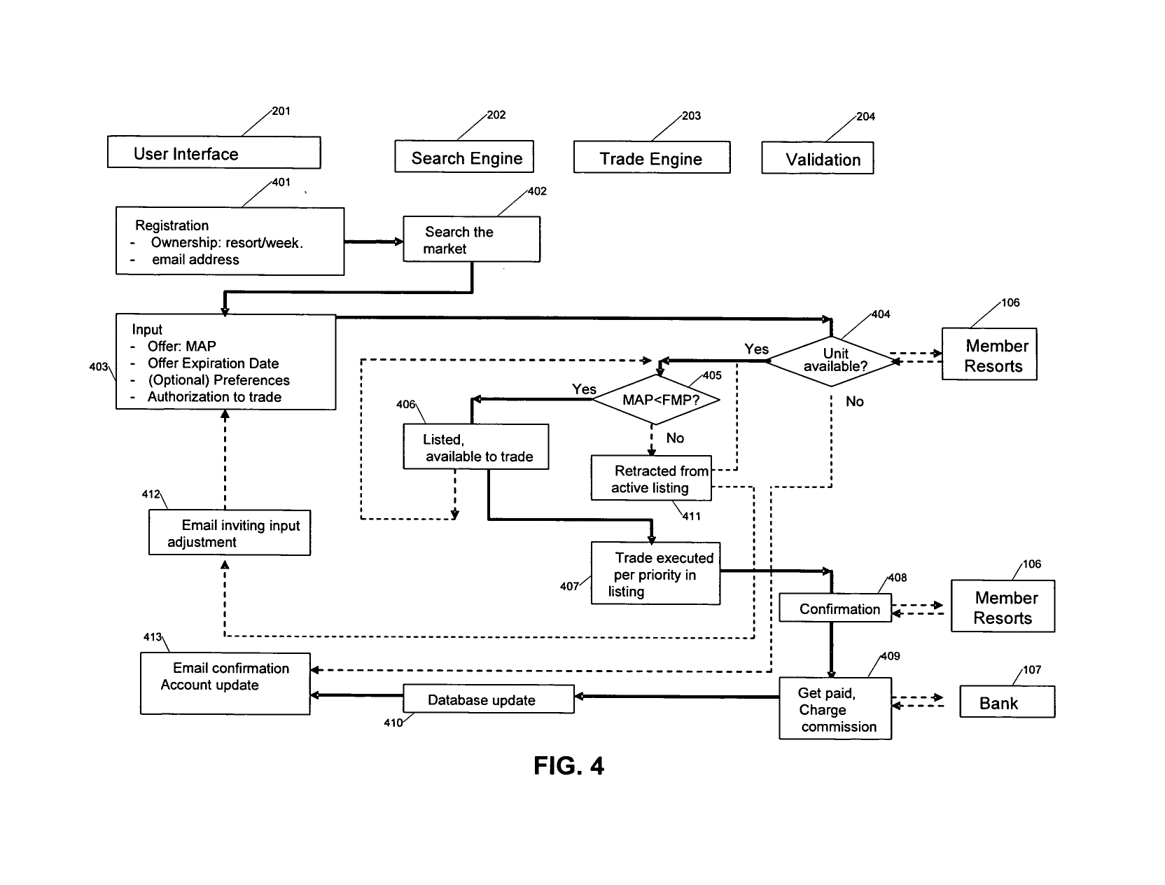

FIG. 4 is a flow diagram illustrating a process of an exchange market platform for the usage of timeshare properties on behalf of a seller according to one embodiment of the invention. Note that process 400 may be performed by processing logic which may include software, hardware, or a combination thereof. For example, process 400 may be performed by system 200 of FIG. 2. For consistency purposes, certain reference numbers are retained from previous figures. Referring to FIG. 4, at block 401, a seller, via user interface 201, registers with the platform and provide ownership information of one or more timeshare properties with the system. At block 402, search engine 202 is invoked to search the market (e.g., market database 205) to gain a basic understanding how his/her timeshare properties is currently traded in the marketplace. In addition, at block 403, additional information is received from the seller via the user interface 201, including the MAP and its expiration date, optional preferences, and/or authorization to trade, etc.

At block 404, the validation module 204 interrogates with the corresponding resort or resorts to verify whether the timeshare property being registered is valid. If the timeshare property has been registered successfully, the timeshare property is committed to the marketplace until successfully traded, or conditions set forth per seller's inputs. At block 405, trade engine 203 compares the MAP and the FMP and if the MAP is less than or equal to the FMP, at block 406, the corresponding timeshare property will be listed available to buyers by search engine 202. If certain trading conditions (e.g., a buyer offers to purchase at FMP, contingency conditions, priorities among peer sellers, etc.) are met, at block 407, the trade is executed by the trade engine 203 and at block 408, a confirmation is sent to the corresponding resort 106 by the validation engine 204. Thereafter, at block 409, the validation engine 204 coordinates with the financial institute 107 associated with the buyer for the payment. Once the payment is received, the trade is committed and at block 410, database is updated and a confirmation email is sent to the buyer and/or the seller at block 413.

On the other hand, if the timeshare property cannot be validated successfully at block 404, an email is sent to the seller at block 413. Further, if the MAP is higher than the FMP at block 405, an email is sent to the seller at block 412 to invite the seller to lower his/her MAP which is processed at block 403 at UI 201. Other operations may also be performed.

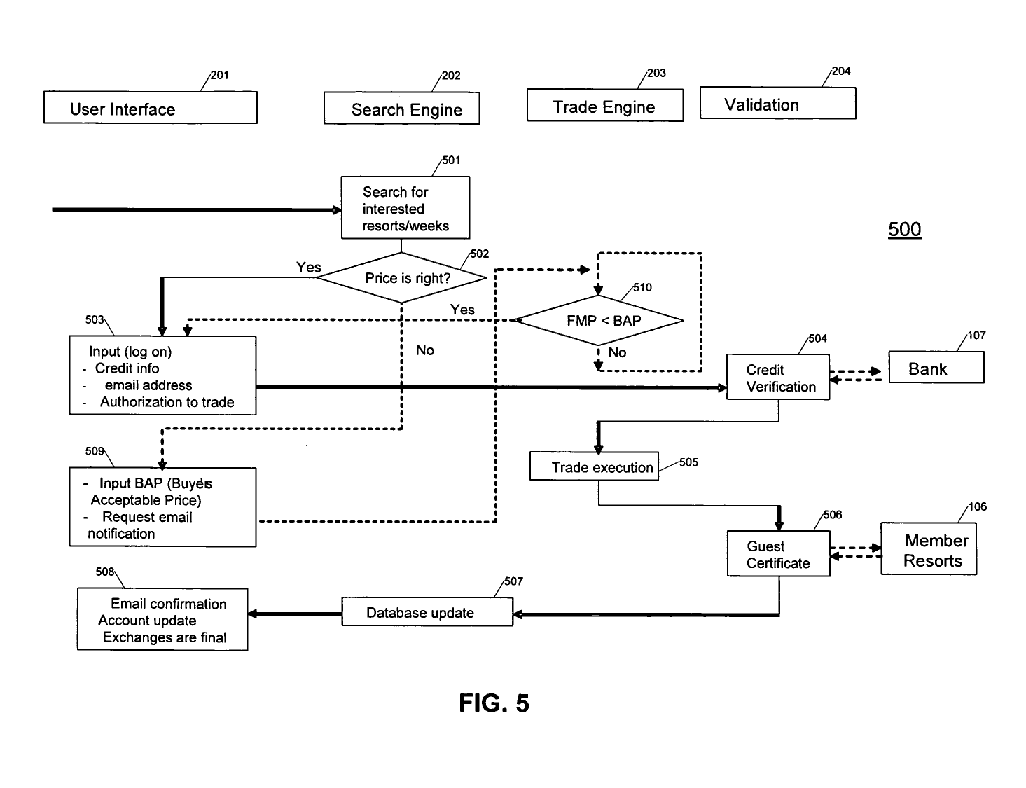

FIG. 5 is a flow diagram illustrating a process of an exchange market platform to process timeshare properties on behalf of a buyer according to one embodiment of the invention. Note that process 500 may be performed by processing logic which may include software, hardware, or a combination thereof. For example, process 500 may be performed by system 200 of FIG. 2. For consistency purposes, certain reference numbers are retained from previous figures. Referring to FIG. 5, in response to a buyer's request received via user interface 201, search engine 202 conducts a search in available inventory in one or more resorts based on buyer's interests. At block 502, if the search engine 202 turns out something that are within the range of buyer's budgets, at block 503, additional information such as credit information, email address, and/or authorization to trade is obtained from the buyer via UI 201. Thereafter, at block 504, validation engine 204 interrogate the financial institute 107 to verify buyer's credits and if success, at block 505, the trade is executed by the trade engine 203. At block 506, the validation engine obtains a guest certificate through the corresponding resort(s) 106 and sends to buyer. The database is updated at block 507 and the buyer and/or seller's accounts are updated at block 508.

On the other hand, if the search engine 202 turns out nothing within the buyer's budget at block 502, additional information such as BAP (buyer acceptance price) is obtained from the buyer via UI 201. The trade engine will continuously monitor the market on behalf of the buyer, constantly or periodically comparing the newly obtained BAP against new inventories and updated FMP at block 510 until the BAP is greater than or equal to the FMP upon which the trade is executed as described above. Alternatively, as the buyer wishes, an e-mail notification will be sent to the buyer to alert him/her the new updates and to invite him/her back to block 503 to proceed on trade. Other operations may also be performed.

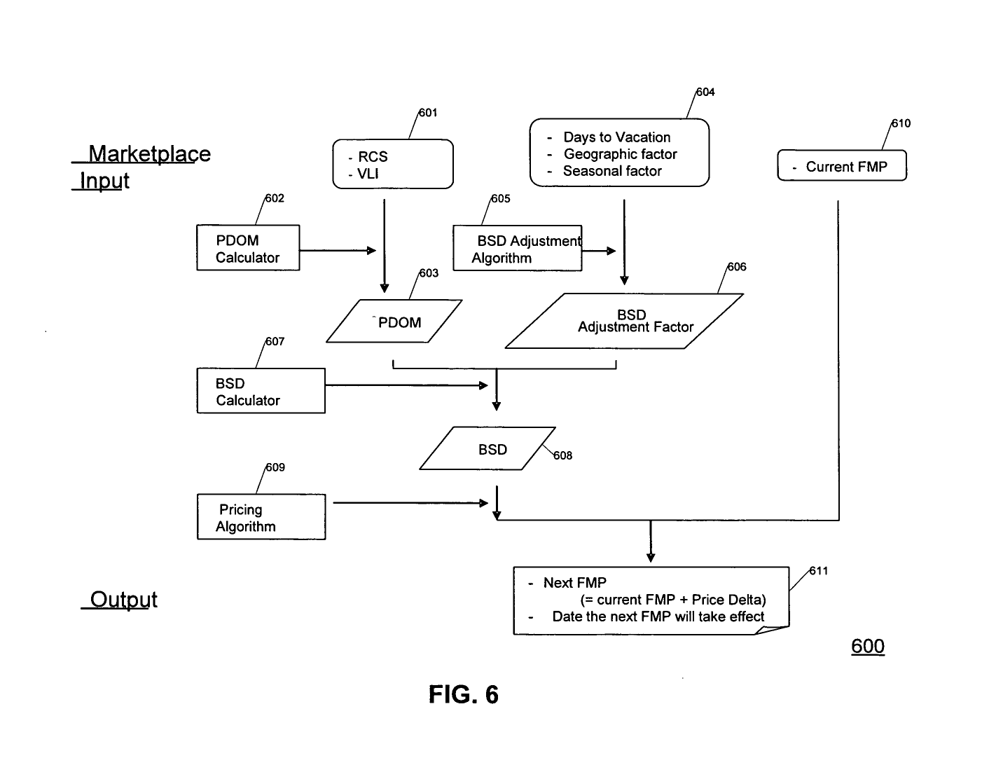

As described above, all trades are executed based on the dynamically determined FMP which is determined constantly or periodically (e.g., daily). FIG. 6 is s flow diagram illustrating a process for determining an FMP of a timeshare property according to one embodiment of the invention. Note that process 600 may be performed by processing logic which may include software, hardware, or a combination thereof. For example, process 600 may be performed by system 200 of FIG. 2 such as, for example, pricing module 206.

Referring to FIG. 6, in one embodiment, PDOM (projected day on market) 603 is calculated by PDOM calculator 602 based on certain inputs 601 such as the number of recently completed sales (RCS) over a last predetermined period of time (e.g., the last 7 days period) and/or the number of valid listed inventory (VLI) such as those having MAP<=FMP. The PDOM is an estimate of how long it takes for a new listing to be sold. The DOM is referred to as the number of days a product (e.g., a timeshare property) is listed (until sold). It is a common measure of market dynamics. The DOM is too long when the sale is slow and it is a call to lower the price. The DOM is too short when the sale is fast and it is an indication price can go higher. For example, for a period of time for 7 days, the PDOM can be determined as follows:

PDOM=(VLI/RCS)*7

In addition, the balance of supply and demand (BSD) adjustment factor (AF) 606 is determined according to a BSD adjustment algorithm 605 based on certain inputs 604, such as, for example, days to vacation, geographic factors, and/or seasonal factors, etc. The BSD 608 is then calculated by a BSD calculator 607 based on the PDOM 603 and BSD adjustment factor 606. In one embodiment, the BSD=PDOM*AF. Based on the BSD 608, the next FMP 611 is determined according to the FMP algorithm 609 and the current FMP 610, as well as the effective date for the next FMP.

As described above, an FMP algorithm is provided herein to gauge the dynamic of the market. A pricing index is generated as a result. FMP is an effort to balance supply and demand from an overall market perspective. The FMP provides an objective price determination for the market price, whereas in the traditional free market, price of the similar product is determined by the cheapest price based on the individual sellers who have the most urge to sell. It is noted that without deviation from the principles illustrated herein,variations in pricing algorithm is possible. It is also possible to gauge the market dynamics based on market parameters other than DOM.

The PDOM is not a direct market indicator as it is relative to the specific market condition. For example, at a certain vacation rental market, when the market is still 9 months ahead of vacation date, one might expect a vacation property listed now to be rented out in 60 days. Therefore, PDOM of 60 days is probably a perfectly balanced market. However, when vacation is only 2 months away, PDOM of 60 days is obviously too long. Instead, one would expect the property listed now be rented out in 2 weeks. As a result, an ideal market at this time probably would like a PDOM of 14 days.

The BSD adjustment algorithm 605 is to normalize PDOM by the impact of various market conditions. BSD (balance of supply and demand) is a measure of market dynamics. Many factors have sound impact to BSD, including seasonal, geographical and cultural factors, as well as the market dynamics of similar products. Below is an example in which AF is a function of days to vacation.

| Days to Vacation | AF (Adjustment Factor) |
|---|---|
| 20 | 7 |
| 60 | 5 |
| 120 | 3 |
| 180 | 2 |
| 360 | 1 |

BSD of 100 is defined as an ideally balanced market that the inventory is consumed by demand at a healthy rate with adequate supply. Advanced algorithm can be also applied here (e.g., moving average or others) to monitor and to dampen the change in BSD. The adjusted BSD will thus not over react to a spike in market variation, but have a sufficient response to a real market move.

Pricing algorithm 609 determines how much price change is expected and how soon it will become effective based on the input on the assessment of the current market dynamics (BSD). Price change could be assessed on absolute value or a percentage of change. Table below lists an example.

| BSD | price delta | interval (days) |
|---|---|---|
| 0-20 | 400 | 4 |
| 20-40 | 300 | 4 |
| 40-60 | 200 | 7 |
| 60-80 | 100 | 7 |
| 80-120 | 0 | 7 |
| 120-140 | −100 | 7 |
| 140-160 | −200 | 7 |
| 160-180 | −300 | 7 |
| More than 180 | −400 | 4 |

In one embodiment, the next FMP=current FMP+price delta. Interval is a parameter to help gauge the urgency how soon the pricing needs to response to a change in market dynamics. If the market is close to a normal condition (BSD˜100), the market probably is better to hold and wait, not to over react to short term market variation. On the other hand, if it deviates significantly from a normal condition (BSD<40 or >160), the pricing need to reassessed immediately. Note that the algorithm given here is a simplified example to illustrate how FMP is generated based on assessment of market dynamics. In a real application, variations can be made and algorithm will be more complicated to calculate the impact of many secondary effects.

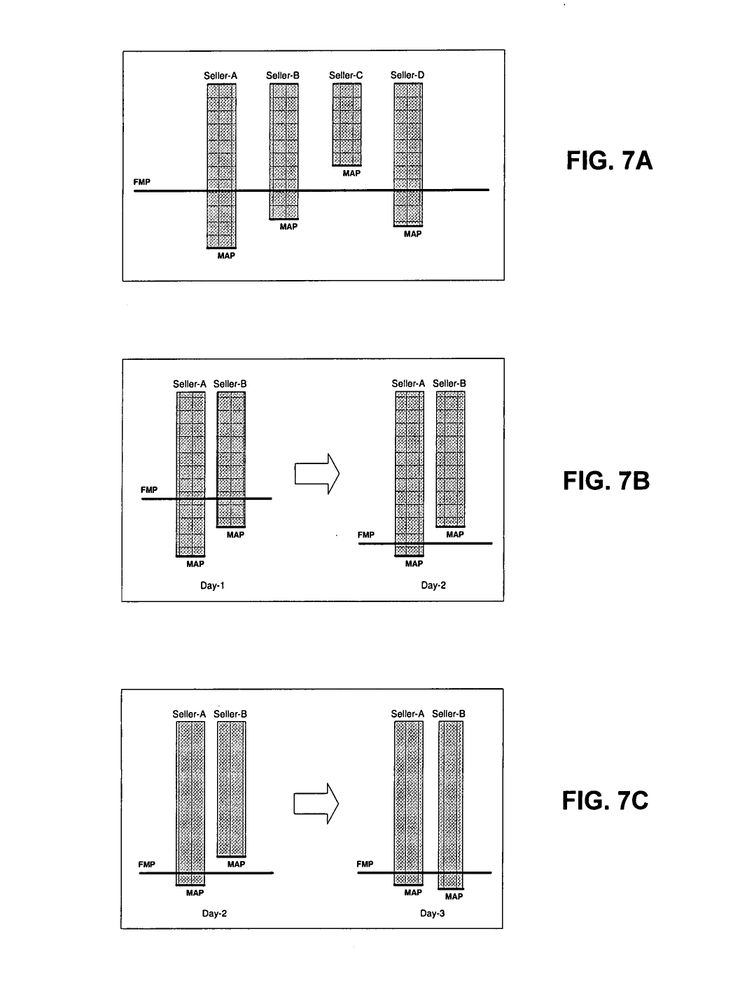

As described above, a trade is executed based on the FMP vs. MAP of a seller. FIGS. 7A-7C are diagrams illustrating an example of a trade to be executed according to certain embodiment of the invention. Referring to FIG. 7A, sellers A, B, C and D offer their products of same nature on the marketplace with their own MAP's they feel comfortable with. Per FMP at this moment, only the products from sellers A, B and D are active in listing and will automatically proceed to transaction once buyers in the marketplace initiate the trading at FMP. Product from seller-C is excluded from potential trading as his/her MAP is above current FMP.

Referring to FIG. 7B, as market condition changes, FMP drifts down from Day-1 to Day-2. In Day-1, both sellers A and B have their product actively listed on the market as their MAP's are all below the FMP of Day-1. Now, in Day-2 as shown in FIG. 7B, while all the MAP's stay the same, the market condition drives FMP to a lower price range. Seller-A will remain active as his/her MAP is still below FMP of Day-2. However, product from Seller-B is retracted from active listing as seller-B's MAP is now above FMP of Day-2. Sellers can change their MAP inputs. As Seller-B noticed that his/her product is not actively listed any more on Day-2, he/she has the option to modify his/her MAP any time to put the product back into the market as shown in FIG. 7C.

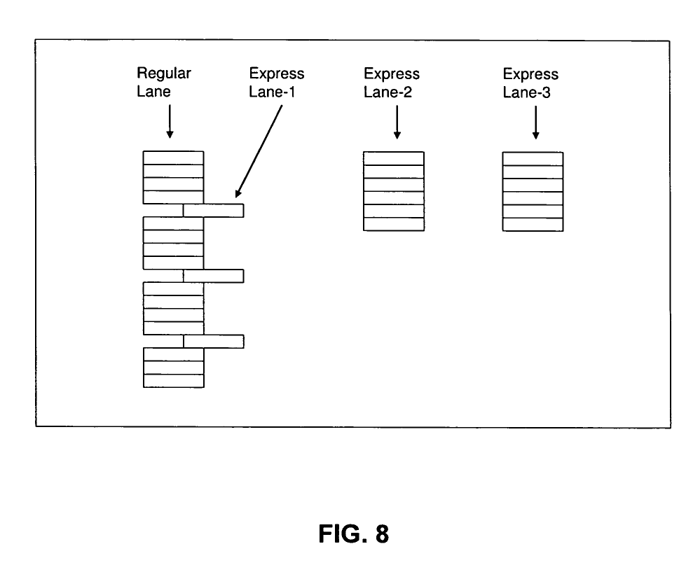

As described above, certain “express lanes” are established for expedite selling of timeshare properties, where the express lanes can be purchased by a seller or sellers. FIG. 8 is a block diagram illustrating an example of configurations of certain types of express lanes according certain embodiments of the invention. Referring to FIG. 8, with respect to a regular lane, as a seller lists his/her product on the market, the seller will get a time stamp when the product is listed. In the regular lane, sellers are lined up according to their time stamps and inventory is cleared accordingly, first-come-first-serve as long as the MAP is below the FMP. One will lose his/her time stamp if his/her product is retracted from active listing for a predefined period, e.g., more than one week. In such case, e-mail notification will send to the seller to remind him/her the status change.

Regarding to Express Lane-1, slots are reserved, e.g., one in every five of the regular lane. The slots are reserved for those late comers who wish to jump ahead. A fee is collected depending on how far ahead one wants to jump, providing the slot is still open. With respect to Express Lanes 2 & 3, express lanes can be alternatively created parallel to regular lane. Express lanes are opened to those who would like to bid a fee and prioritized according to the bidding, with highest bid take the immediate spot. One's position is not secured in such a lane as his/her position can be taken anytime by other sellers whoever outbid him/her. A seller in express lane keeps his/her time stamp in the regular line as a default position. The express lanes are also opened to non-monetary factors, e.g., as a reward to a loyal seller, for Golden members, and/or to award a seller who has just been a buyer. The inventory in these express lanes is cleared parallel to the regular lane. For example, the regular lane may be closed to sales 3-6 pm every day. Any trade executed during these hours is directed to drain inventory in the express lanes. Alternatively, Monday of the week can be reserved for express lanes. Other configurations may exist.

A sale in this marketplace is between an individual buyer and an individual seller and thus is not refundable. However, according to one embodiment, the marketplace does provide the buyer certain privileges. For example, if the buyer determines that given the situations now he/she needs to bring his/her purchased timeshare back to the market, the selling of this timeshare will be given certain priority.

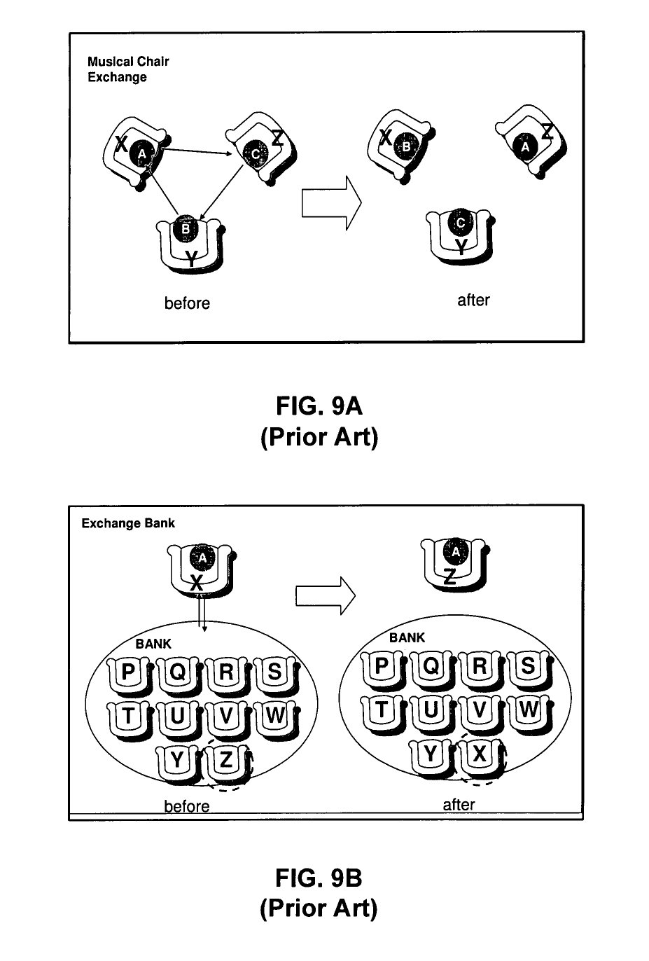

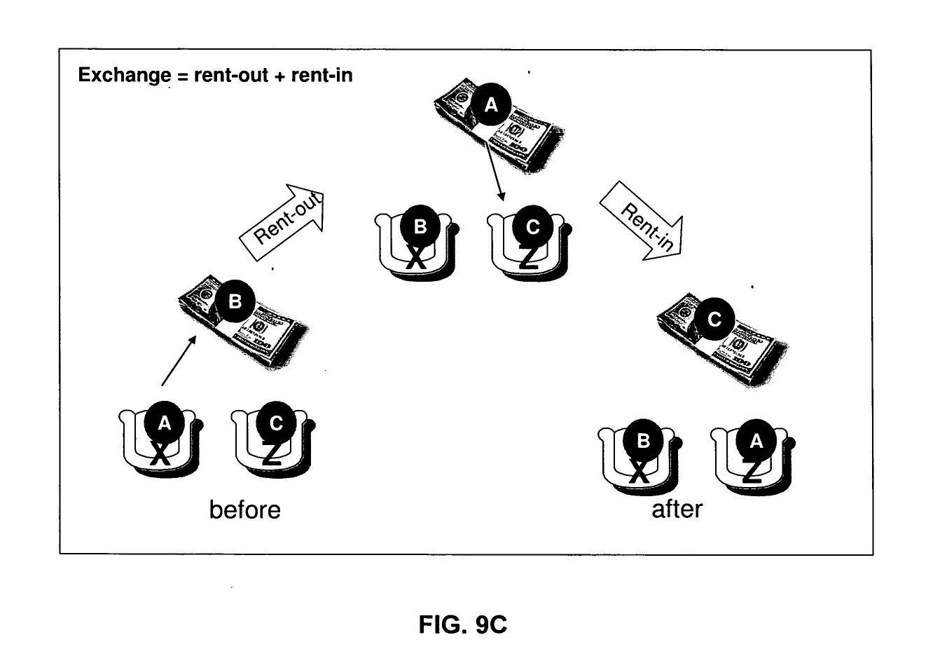

In traditional exchange services, an exchange is conducted through a like-to-like exchange, whereas an exchange is preceded through a complicated multi-party match-making system. FIGS. 9A-9B are diagrams illustrating typical certain exchange models. Referring to FIG. 9A, which is referred to as a “musical chair” exchange model, owner A owns product X and would like to exchange into product Z. The exchange service locates owner C who owns product Z. However, owner C is interested in product Y instead. The exchange service moves on to find owner B who happens to own product Y and wants product X. As a multi-party match is found, exchange is executed so that owner A has product Z, owner C with product Y, and owner B with product X. In this configuration, match making is an extremely complicated system to operate with a very low efficiency.

A more sophisticated version of the musical chair is the so called “exchange bank” model as shown in FIG. 9B. In this model, the exchange service operates an inventory bank. Owner A has a product X. He/she finds product Z in the bank as what he/she is interested in. Owner A requests an exchange between the bank and owner A. Consequently, owner A carries away product Z leaving the bank with his/her product X, available for others to exchange into. In the “exchange bank” model, the service provider owns and operates a “bank” of the inventory, is therefore also an exchange partner. Similar to the musical chair model, the exchange bank model is a closed market barter systems with no currency media. The exchange system are not effective. Additionally, the exchange systems are segregated systems from the rental market and offer little liquidity to the owners.

According to one embodiment of this invention, a currency representation (e.g., club points, digital currency, etc.) or a real currency of a nation is used as exchange media for timeshare exchange. FIG. 9C is diagram illustrating an example of the exchange model according to one embodiment of the invention. In this exchange model, exchange is preceded in two steps; each is an open market rental process. Owner A with product X first puts his/her product X on the market. Trade is executed at the FMPx for product X. As a result, owner A retains an income. Owner A proceeds with the second step process, whereas, owner A uses his/her income to buy in product Z at FMPz. A complete exchange is thus an exchange of X to a currency and then the currency to Z. Note that FMPx and FMPz is not necessarily the same as each product is traded at its own market value at the time trade is executed. Owner A may have to put in additional cash or may end up with extra cash, depending on the relative value of original product X vs. the final product Z. The use of the currency facilitates the exchange process and naturally results fair market valuation to timeshare units. Additionally, according to one embodiment of the invention, an incentive program is established here. A seller may receive credits in renting out his/her timeshare and the credits can be used to subsidize as he/she moves on to rent in a second timeshare. It is also noted that the 2 step exchange does not necessary follow the sequential order. Owner A may get credit or put up cash to first trade-in product Z and then trade-out product X. Embodiments of the invention teach that the exchange and rental are indeed two intrinsically connected market needs, whereas exchange is essentially a two sequential rental process (e.g., rent-out plus rent-in). By combining the rental and exchange market, it offers a large supply of inventory and customers to the rental market and liquidity to exchange users. It should be also noted that the exchange here is not necessarily be carried out via a national currency. It might be implemented with digital virtue currency or club points.

FIGS. 10A-10F are examples of graphical user interfaces (GUIs) for an exchange market platform according to certain embodiments of the invention. For example, GUIs as shown in FIGS. 10A-10F may be implemented as part of user interface 201 of FIG. 2. Referring to FIG. 10A, a user (e.g., a buyer and/or a seller) can register and login from the user interface to configure its account (e.g., preferences, MAP, BAP, etc.) A user can also perform a search based on certain characteristics of the timeshare properties or according to certain calendar dates. A user can also perform an advanced search based on certain resorts. A search result may be displayed as a resort comparison table as shown in FIG. 10B, highlighting the major features of a resort, as well as the offer price, rating or reviews, etc. In response to a selection, certain detailed information of the selected timeshare property may be displayed as shown in FIG. 10C, including details of resort amenities and pictures of the selected resort. Additionally, a buyer can check the availability of the searched items as shown in FIG. 10D. If a buyer is satisfied with the selection, the buyer may proceed to purchase at the offer price (e.g., FMP) as shown in FIG. 10E. Alternatively, a seller may offer his/her timeshare unit to the market with his/her own input of MAP as shown in FIG. 10F. In this example as shown in FIG. 10F, a seller can set a MAP for a particular timeshare property in view of a current offer (e.g., a current FMP) of the timeshare property. Note that FIGS. 10A-10F are shown for purposes of illustration only; other formats or GUIs may also be implemented.

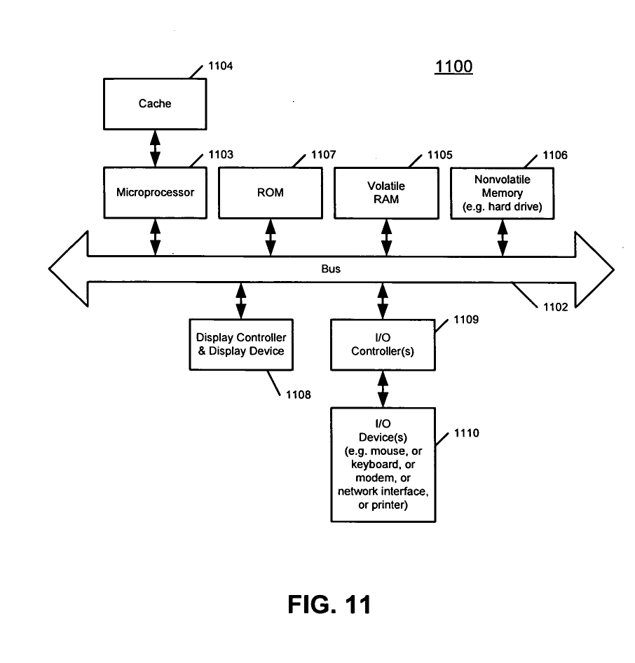

FIG. 11 is a block diagram of a data processing system which may be used with one embodiment of the invention. For example, the system 1100 shown in FIG. 11 may be used as a computer system such as clients 101-102 or servers 104 of FIG. 1. Note that while FIG. 11 illustrates various components of a computer system, it is not intended to represent any particular architecture or manner of interconnecting the components; as such details are not germane to the present invention. It will also be appreciated that network computers, handheld computers, cell phones, and other data processing systems which have fewer components or perhaps more components may also be used with the present invention. The computer system of FIG. 11 may, for example, be an Apple Macintosh computer or an IBM compatible PC.

As shown in FIG. 11, the computer system 1100, which is in a form of a data processing system, includes a bus or interconnect 1102 coupled to a processor 1103 and a ROM 1107, a volatile RAM 1105, and a non-volatile memory 1106. Processor 1103 may include multiple processors and/or core logics that constitute central processing units (CPUs) of the system and thus, control the overall operations of the system. According to certain embodiments, processor 1103 accomplish this by executing software stored in any of the memories 1105-1107, such as, for example, applications and operating system, etc. Processor 1103 may include, one or more programmable general-purpose or special-purpose microprocessors, digital signal processors (DSPs), programmable controllers, application specific integrated circuits (ASICs), programmable logic devices (PLDs), or the like, or a combination of such devices.

The processor 1103, which may be, for example, an Intel processor or a PowerPC processor, is coupled to cache memory 1104 as shown in the example of FIG. 11. The bus 1102 interconnects these various components together and also interconnects these components 1103 and 1105-1107 to a display controller and display device 1108, as well as to input/output (I/O) devices 1110, which may be mice, keyboards, modems, network interfaces, printers, and other devices which are well-known in the art.

Typically, the input/output devices 1110 are coupled to the system through input/output controllers 1109. The volatile RAM 1105 is typically implemented as dynamic RAM (DRAM) which requires power continuously in order to refresh or maintain the data in the memory. The non-volatile memory 1106 is typically a magnetic hard drive, a magnetic optical drive, an optical drive, a DVD RAM, a Flash memory, or other type of memory system which maintains data even after power is removed from the system. Typically, the non-volatile memory will also be a random access memory, although this is not required.

While FIG. 11 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 1102 may include one or more buses connected to each other through various bridges, controllers, and/or adapters, as is well-known in the art. In one embodiment, the I/O controller 1109 includes a USB (Universal Serial Bus) adapter for controlling USB peripherals. Alternatively, I/O controller 1109 may include an IEEE-1394 adapter, also known as FireWire adapter, for controlling FireWire devices. Other components may also be included.

Thus, techniques for providing exchange market platform for timeshare properties have been described herein. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer implemented method for establishing an exchange marketplace and managing the usage of timeshare properties, the method comprising:
determining a fair market price (FMP) for possessing a timeshare property for a predetermined period of time, the FMP being determined independent of buyers and sellers of a plurality of timeshare properties, the timeshare property being one of the plurality of timeshare properties; and
in response to an offer from a buyer to buy the timeshare property, executing a trade transaction at the FMP associated with the timeshare property, if the FMP is higher than or equal to a minimum acceptance price (MAP) of a seller currently owning a right of possessing the timeshare property.

2. The method of claim 1, wherein the FMP of the timeshare property is dynamically monitored and adjusted in real time for every predetermined time interval in view of the supply and demand of the plurality of timeshare properties, each having an associated and independently determined FMP.

3. The method of claim 1, further comprising:
for each predetermined time interval, listing a timeshare property of the plurality of timeshare properties available for rental if a MAP of the timeshare property is below or equal to the FMP, wherein the MAP is offered by the seller currently owning a right of possessing the timeshare property, but is invisible to a buyer who seeks rental usage; and
retracting the time share property from the listing if the MAP of the timeshare property is higher than the FMP such that the retracted timeshare property is unavailable for bidding.

4. The method of claim 2, wherein determining an FMP comprises:
estimating how long the timeshare property would likely be on the market before the timeshare property is rented out based on recently completed transactions;
determining an adjustment factor based on individual characteristics of the timeshare property; and
determining a balance of supply and demand (BSD) consideration for the timeshare property in view of the adjustment factor and estimation how long the timeshare property would likely be on the market, wherein the FMP of the timeshare property is calculated based on the determined BSD.

5. The method of claim 4, wherein how long the rental of the timeshare property would likely be on the market is determined based on the number of timeshared properties available for bidding in view of the number of recently completed transactions over a predetermined period of time.

6. The method of claim 4, wherein the adjustment factor is determined based on how far between a current time and a vacation time associated with the timeshare property, a geographical factor associated with the timeshare property, and a seasonal and cultural factor associated with the timeshare property.

7. The method of claim 4, further comprising:
computing a price delta based on the BSD, and a time interval representing how soon the FMP of the timeshare property needs to be changed; and
determining an FMP of the timeshare property for a next time period based on a current FMP of a current time period and the price delta.

8. The method of claim 1, further comprising prioritizing a plurality of sellers of at least a portion of the plurality of timeshare properties according to one or more priority schemes, wherein certain sellers have higher priorities to rent out their timeshare properties comparing a remainder of the sellers.

9. The method of claim 8, further comprising allocating a plurality of priority slots for prioritizing sellers, wherein the priority slots can be allocated according to a predetermined number based on a predetermined ratio of the priority slots relative to common slots, and wherein the priority slots can be allocated according to a pre-designated time of the day, or dates of the week that is reserved for serving priority selling.

10. The method of claim 8, further comprising providing a first priority channel having a predetermined number of priority slots to rent out a timeshare property, wherein a seller can purchase with a fixed fee a priority slot to expedite the renting of his/her timeshare property over other sellers, and wherein the seller cannot purchase a priority slot if all of the predetermined number of priority slots have been purchased.

11. The method of claim 8, further comprising providing a second priority channel having a plurality of priority slots available for bidding by sellers to expedite renting out their timeshare properties over other sellers.

12. The method of claim 8, further comprising providing a third priority channel having a plurality of priority slots available for sellers who hold certain privileges.

13. The method of claim 12, wherein a seller receives certain priorities is selling if the seller has completed another trade transaction to buy the right to possess another timeshare property.

14. The method of claim 12, wherein the trade transaction is nonrefundable, wherein the buyer can bring back the timeshare property the buyer rented in for listing again and receiving certain priorities in selling.

15. The method of claim 1, wherein the buyer and seller receives incentives for their trade transaction, which are transferable and subject to expiration, and can be used to subsidize future trade transactions.

16. The method of claim 1, further comprising in response to requests, sending emails to users regarding dynamics of market conditions and current FMP of a particular timeshare property.

17. The method of claim 1, wherein the FMP represents an absolute currency value of a predetermined type of a nation's currency.

18. A computer implemented method for establishing an exchange marketplace and managing the usage of timeshare properties, the method comprising:
listing a plurality of timeshare properties to be rented by a buyer for use for a predetermined period of time; and
for each of the plurality of timeshare properties, determining a fair market price (FMP) for the predetermined period of time in view of supply and demand of a plurality of timeshare properties having similar characteristics available for the predetermined period of time, the FMP being determined independent of buyers and sellers and used for trading the plurality of timeshare properties, wherein determining the FMP includes
estimating how long the timeshare property would likely be on the market before the timeshare property is rented out based on recently completed transactions,
determining an adjustment factor based on individual characteristics of the timeshare property, and
determining a balance of supply and demand (BSD) consideration for the timeshare property in view of the adjustment factor and estimation how long the timeshare property would likely be on the market, wherein the FMP of the timeshare property is calculated based on the determined BSD.

19. The method of claim 18, wherein how long the rental of the timeshare property would likely be on the market is determined based on the number of timeshared properties available for bidding in view of the number of recently completed transactions over a predetermined period of time.

20. The method of claim 18, wherein the adjustment factor is determined based on how far between a current time and a vacation time associated with the timeshare property, a geographical factor associated with the timeshare property, and a seasonal and cultural factor associated with the timeshare property.

21. The method of claim 18, wherein determining the FMP further comprises:
computing a price delta based on the BSD and an time interval representing how soon the FMP of the timeshare property needs to be changed; and
determining an FMP of the timeshare property for a next time period based on a current FMP of a current time period and the price delta.

22. A computer implemented method for establishing an exchange marketplace and managing the exchange of the usage of timeshare properties, the method comprising:
for each of a plurality of timeshare properties available to be rented for use for a predetermined period of time, determining a fair market price (FMP) for the predetermined period of time in view of supply and demand of a plurality of timeshare properties having similar characteristics available for the predetermined period of time, the FMP being determined independent of buyers and sellers and used for trading the plurality of timeshare properties; and
providing an incentive mechanism such that a seller renting out a first timeshare property receives incentives and applies the incentives to rent a second timeshare property at a discount.

23. The method of claim 22, wherein the FMP represents an absolute currency value of a predetermined type of a nation's currency.

24. The method of claim 22, wherein the FMP represents a digital currency or a club point system.

25. A computer implemented method for establishing and managing a marketplace, the method comprising:
determining a fair market price (FMP) for a product of a plurality of products, the FMP being determined independent of buyers and sellers of the plurality of products; and
in response to an offer from a buyer to buy the product, executing a trade transaction at the FMP associated with the product, if the FMP is higher than or equal to a minimum acceptance price (MAP) of a seller currently owning the product.
